(19) United States
(12) Patent Application Publication
(10) Pub. No.: US 2009/0101768 A1
(43) Pub. Date: Apr. 23, 2009

(54) Magnet stand and assembly

(75) Inventor: Andrew G. Wert, Avon, CT (US)

Correspondence Address: John Yankovich;Ohlandt, Greely, Ruggiero & Perle, L.L.P., 10th Floor, One Landmark Square, Stamford, CT, 06901-2682, US

(73) Assignee: AM Wert & Associates, LLC

(21) Appl. No.: 12/151,166

(22) Filed: May 5, 2008

Related U.S. Application Data
(60) Provisional application No. 61/000,069, filed on Oct. 23, 2007.

(51) Int. Cl. F16M 13/00

(52) U.S. Cl. 248/127

(57) ABSTRACT

There is a magnet stand assembly. The assembly has a base, an upright member, and a magnet bearing decorative or informational indicia. The upright member is connected with the base and extends generally perpendicularly with respect to the base. The base is adapted to be positioned on a generally flat, horizontal surface and the upright member is adapted to be vertically disposed. The upright member has a face of a metal attractive to a magnet and the magnet is attracted to and retained by the face. There is also a magnet stand.

### CROSS-REFERENCE TO RELATED APPLICATIONS

The present application claims priority from U.S. Provisional Application No. 61/000,069, filed Oct. 23, 2007, which is incorporated herein by reference.

### BACKGROUND OF THE INVENTION

1. Field of the Invention

The present invention relates to a magnet stand adapted to display a magnet in an upright position. The present invention also relates to a magnet stand assembly displaying a magnet in an upright position.

2. Description of the Related Art

Magnets have also been used to bear or display decorative or informational indicia. Magnets have also been fabricated into various shapes, and, when combined with indicia, resemble iconographic images, animals or various characters.

It would be desirable to have a stand enabling display of magnets such that the magnet largely obscures the view of the stand and is the primary focus of the display. It would also be desirable if the dimensions of the upright surface enable the magnet to be positioned at various heights and angles for optimum effect. It would also be desirable to have a stand enabling display of magnets in an upright position thus transforming an object traditionally displayed on a two-dimensional surface to a three-dimensional toy or object of display in order to promote a new interactivity in pretend play. It would be further desirable to have a device enabling display of magnets in an upright position with respect to a horizontally disposed surface, such as a tabletop, desktop, or countertop. It would also be desirable if the size of the stand was such that it enabled a horizontally displayed magnet, especially one with decorative indicia or a unique shape, to be ambulatory and be displayed or played with as a toy by a child. It would also be desirable to package the stand and the magnet together, as in the nature of a kit. It would also be desirable if the stand could be designed so that it could be assembled and disassembled by the end user for ease of packaging and transportability.

### SUMMARY OF THE INVENTION

According to the present invention, there is a magnet stand assembly. The assembly has a base, an upright member, and a magnet bearing decorative or informational indicia. The upright member is connected with the base and extends generally perpendicularly with respect to the base. The base is adapted to be positioned on a generally flat, horizontal surface and the upright member is adapted to be vertically disposed. The upright member has a face of a metal and the magnet is attracted to and retained by the face.

Further according to the present invention, there is provided a magnet stand. The magnet stand has a base and an upright member. The upright member is connected with the base and extends generally perpendicularly with respect to the base. The base is adapted to be positioned on a generally flat, horizontal surface, and the upright member is adapted to be vertically disposed. The upright member has a face of a metal attractive to a magnet and is adapted to receive and retain the magnet.

### DESCRIPTION OF THE FIGURES

FIG. 1 is a perspective view of a base of a magnet stand of the present invention.

FIG. 2 is a perspective view of a base and an upright member being positioned by hand to form a magnet stand of the present invention.

FIG. 3 is a perspective view of a magnet stand of the present invention.

FIG. 4 is a front perspective view of a magnet stand assembly of the present invention using the magnet stand of FIG. 3 and a decorative magnet.

FIG. 5 is a top view of the assembly of FIG. 4.

FIG. 6 is a perspective side view of the assembly of FIG. 4.

FIG. 7 is a perspective rear view of the assembly of FIG. 4.

FIG. 8 is a top view of is a perspective view of a base of a magnet stand of the present invention with a rotatable slot receptacle.

FIG. 9 is a perspective view of another embodiment of a magnet stand assembly of the present invention.

FIG. 10 is a perspective view of the magnet stand assembly of FIG. 9 except that the magnet has been repositioned.

FIG. 11 is a plan view of a kit showing an embodiment of a magnet stand assembly of the present invention in disassembled form.

FIG. 12 is a top view of a workpiece from which a base and an upright member of a magnet stand can be formed.

FIG. 13 is a front perspective view of embodiment of a magnet stand of the present invention formed from the workpiece of FIG. 9.

FIG. 14 is a front perspective view of a magnet stand assembly according to the present invention with a decorative magnet applied to the magnet stand of FIG. 10.

### DETAILED DESCRIPTION OF THE INVENTION

The magnet stand of the present invention enables display of magnets in an upright position on a tabletop, countertop, or desktop. A magnet stand having a magnet attached thereto is referred to herein as a magnet stand assembly.

The magnet stand and magnet stand assembly of the present invention are useful with any kind of magnet that is attracted to a metal. Magnets are useful for bearing decorations, advertisements, slogans, and the like. Magnets are also useful as toys or articles of play. Magnets can also be formed or fabricated into shapes, and, when combined with indicia, convey or depict iconographic images, animals, and various real and imaginary characters.

The magnet stand and magnet stand assembly of the present invention are useful with any kind of magnet that is attracted to a metal. The size and dimensions of the magnet relative to the face of the upright member of the magnet stand assembly are such that the face is substantially or entirely obscured. There is sufficient attraction between the face and the magnet to maintain the magnet in an upright position and stationary position. The weight of the magnet stand assembly (including the components of the magnet stand and the magnet) are less than 16 ounces. The light weight renders the assembly ambulatory and enables it to be used as a moveable display or a toy.

The base and the upright member, the primary structural components of the magnet stand, may be composed of any conventional structural material, such plastics, wood, and metals. Plastics are preferred because of their low cost and ease of fabrication.

The base is shaped and configured to be situated or positioned on a substantially flat surface and provide stability for the upright member. The base can take any geometric shape that can provide stability, including but not limited to a rectangle, a square, a circle, an oval, a triangle, an H-shape, a U-shape, a V-shape, or an X-shape. The base will have one or more slots or indentations therein to receive the lower end of the upright member and allow it to fit into the base. The position of the upright member and attached magnet relative to the base is designed to ensure that the assembly maintains center of gravity necessary for stability of the overall assembly.

The upright member will have a face that is composed of a metal attractive to magnets. Examples of metals that are attractive to magnets are the ferrous metals, which are composed partially or substantially of iron. If desired, the entirety of the upright member may be composed of an attracting metal or may be composed of a non-attracting metal with a face of an attracting metal. Alternately, the upright member may be composed of another substance but have a face of an attracting metal in the form of a layer, sheet, foil, coating, deposition, or an equivalent structure thereof. A preferred upright member is composed substantially of a plastic and has a face with a coating or deposition of an attracting metal.

The face of the upright member will provide enough surface area relative to the size of the magnet to enable the magnet to be held in a stable manner as well as be positioned at different locations, heights, and angles along the face.

The upright member is connected with the base and extends generally perpendicularly with respect to the base. The upright member is adapted to be vertically disposed with respect to the base. The upright member preferably has one or more extending tabs or protrusions that are designed to fit within corresponding slots or indentations in the base. The tabs or protrusions can optionally be magnetically attractive with portions of the base contiguous to the slots or indentations in the base to further enhance stability. Combinations of magnets or combinations of magnets and attractive metals can be located in proximity to the tabs/protrusions and the slots/indentations. The extending tabs or protrusions are designed with a tolerance such that the components fit within corresponding slots or indentation in the base, and can be assembled and dissembled for ease of packaging and transportability.

The primary components of the magnet stand, the base and the upright member, can be formed discretely and separately from separate workpieces (two-piece) and subsequently joined or can be formed together, i.e., unitarily, from the same workpiece (one-piece), as desired.

In a preferred embodiment, the magnet largely obscures the view of the stand and is the primary visual focus of the magnet stand assembly. The spatial dimensions of the face of the upright member enable the magnet to be positioned at various heights and angles for optimum visual and pretend play effect. The assembly has the visual effect of transforming a magnet, an object traditionally displayed on a two-dimensional surface, to a three-dimensional toy or object of display. The assembly is in an upright position with respect to a horizontally disposed surface, such as a tabletop, desktop, or countertop. The assembly is ambulatory and can be moved or relocated at will to facilitate play as a toy by a child. The components of the assembly can be provided in a consumer package in the nature of a kit. The assembly is designed so that the components thereof can be assembled and disassembled by the end user for ease of packaging and transportability.

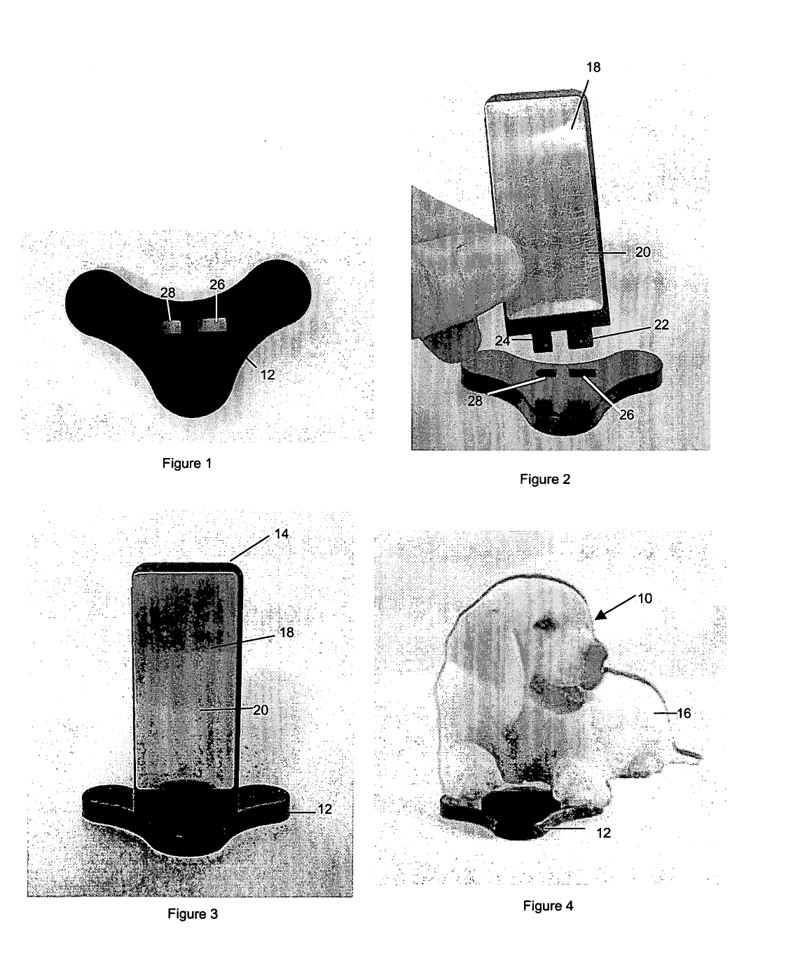

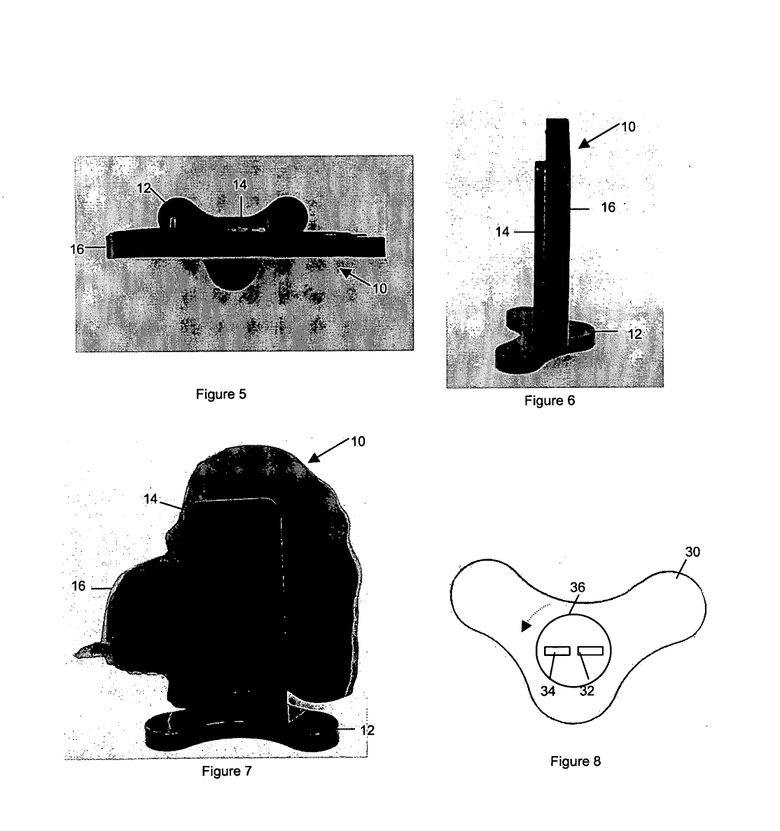

An embodiment of an assembly of the present invention is generally referenced by the numeral 10 and is shown in FIG. 4. Assembly 10 has a base 12, an upright member 14, and a magnet 16 bearing decorative or informational indicia. Upright member 14 is connected, i.e., coupled, with base 12 and extends generally perpendicularly or normally with respect to base 12 or a plane thereof. Upright member 14 has first and second tabs 22 and 24 extending therefrom, which fit into corresponding first and second slots 26 and 28, respectively, in base 12. Tabs 22 and 24 are designed with a tolerance relative to slots 26 and 28 to enable assembly and disassembly of assembly 10. FIGS. 1 to 3 show various views of base 12, upright member 14, and a coupled combination thereof. Base 12 is adapted to be positioned on a generally flat, horizontal surface (not shown), and upright member 14 is adapted to be vertically disposed with respect to the flat, horizontal surface and base 12. Upright member 14 has a metallized surface 18 at a face 20 of a metal attractive to magnet 16 and is adapted to receive and retain magnet 16. As shown in FIGS. 4 to 7, magnet 16 is attracted to and retained by face 20. Base 12 and upright member 14 are preferably composed substantially of plastic except for metallized surface 18.

FIG. 8 shows a base 30, another embodiment of a base useful in an assembly of the present invention (not shown). Base 30 has a rotatable member 36, which defines first and second slots 32 and 34. The positioning of a magnet stand (not shown) can be varied according to the rotation of member 36.

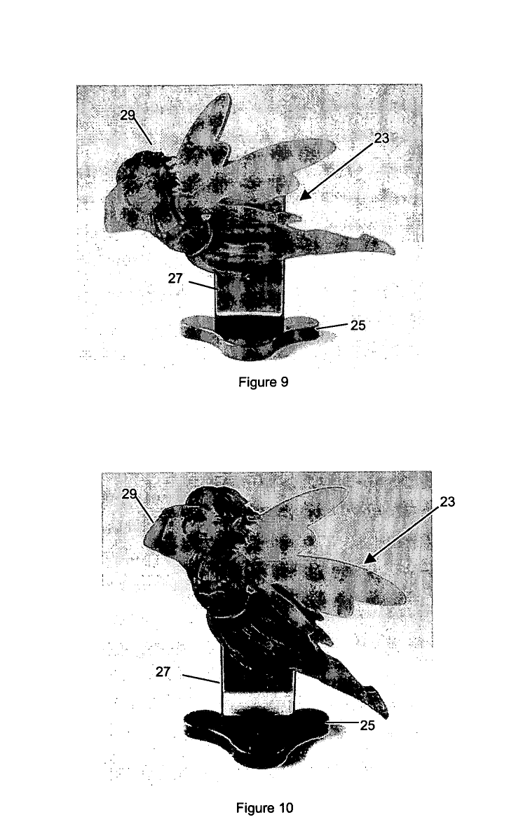

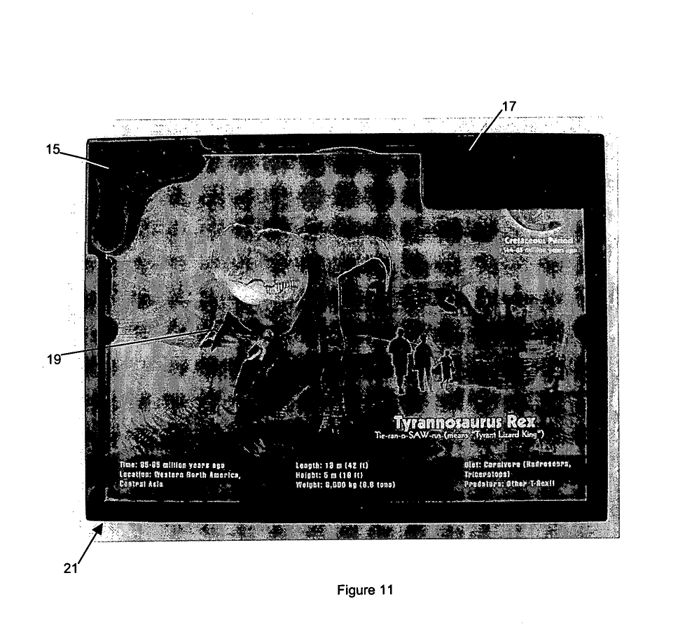

Another embodiment of a magnet stand assembly is shown in FIGS. 9 and 10 and is generally referenced by the numeral 23. Assembly 23 has a base 25, an upright member 27, and a magnet 29. FIGS. 9 and 10 show that the position, orientation, and angle of magnet 29 can be varied with respect to upright member 27 for optimum visual effect.

FIG. 11 shows a kit 21, which is adapted to display a magnet stand assembly in a disassembled form suitable for consumer presentation and sale. In addition to functioning as a display, kit 21 also functions as a shipping container. For purposes of illustration, a base 15, an upright member 17, and a magnet 19 are shown in disassembled form in kit 21.

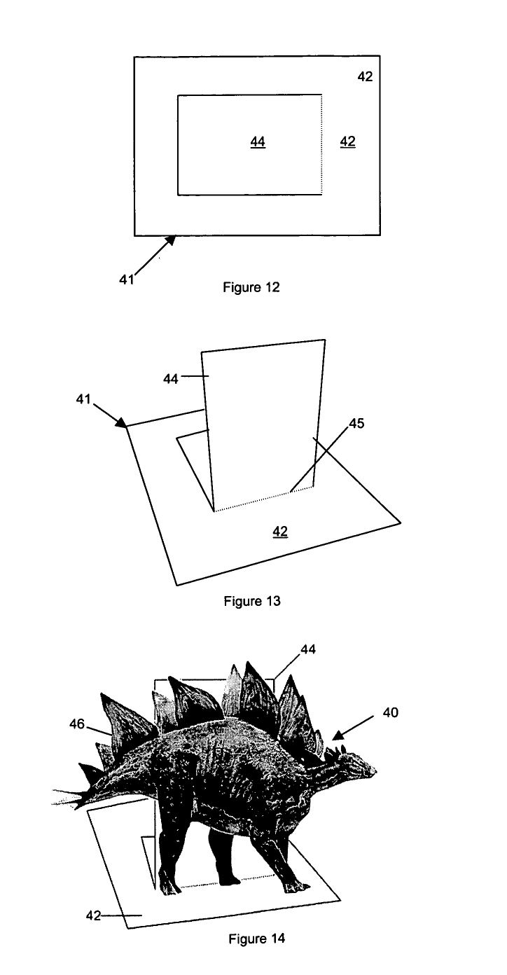

Another embodiment of an assembly of the present invention is generally referenced by the numeral 40 and is shown in FIG. 12. Assembly 40 has a base 42, an upright member 44, and a magnet 46 bearing decorative or informational indicia. In this embodiment, base 42 and upright member 44 are formed from a unitary workpiece 41. Workpiece 41 takes the form of a thin sheet of a metal that is attractive to magnets and is foldable yet exhibits a memory effect, which is shown in FIGS. 12 and 13. To facilitate a perpendicular configuration and actuation between base 42 and upright member 44, workpiece 41 may be hinged or creased along an axis or fold line 45. If desired, an alternative embodiment could be formed with a plastic base and an upright member of a metal (not shown).

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A magnet stand assembly, comprising: a base, an upright member, and a magnet bearing decorative or informational indicia; wherein the upright member is connected with the base and extends generally perpendicularly with respect to the base; wherein the base is adapted to be positioned on a generally flat, horizontal surface and the upright member is adapted to be vertically disposed; and wherein the upright member has a face of a metal with the magnet being attracted to and retained by the face.

2. The assembly of claim 1, wherein the base is substantially of plastic, and wherein the upright member is substantially of plastic and the face thereon is of a metallized layer.

3. The assembly of claim 1, wherein the base and the upright member is substantially of the metal.

4. The assembly of claim 1, wherein the upright member has one or more tabs extending therefrom, wherein the base has one or more corresponding slots therein adapted to receive the one or more tabs.

5. The assembly of claim 4, wherein the one or more tabs and a portion or portions of the base proximal to the slots are magnetically attracted.

6. The assembly of claim 5, wherein the upright member has two tabs extending therefrom, wherein the base has two slots therein adapted to receive the two tabs.

7. The assembly of claim 1, wherein the base and the upright member are separately formed then connected together.

8. The assembly of claim 1, wherein the base and the upright member are formed from the same workpiece.

9. The assembly of claim 8, wherein the upright member is generally perpendicular with respect to the base.

10. The assembly of claim 1, wherein the magnet substantially covers the face.

11. The assembly of claim 1, wherein the magnet can be positioned variously about the face.

12. The assembly of claim 1, wherein the assembly weighs less than 16 ounces.

13. The assembly of claim 1, wherein the base, upright member, and magnet can be assembled and disassembled.

14. The assembly of claim 1, wherein the base, upright member, and magnet are adapted to be provided disassembled in a kit form and subsequently assembled to form the assembly.

15. A magnet stand, comprising: a base and an upright member; wherein the upright member is connected with the base and extends generally perpendicularly with respect to the base; wherein the base is adapted to be positioned on a generally flat, horizontal surface and the upright member is adapted to be vertically disposed; and wherein the upright member has a face of a metal attractive to a magnet and adapted to receive and retain the magnet.
